(19) United States
(12) Patent Application Publication
(10) Pub. No.: US 2018/0281531 A1
(43) Pub. Date: Oct. 4, 2018

(54) TUBELESS TIRE ASSEMBLY

(71) Applicant: Brian Parker, Newbury Park, CA (US)

(72) Inventor: Brian Parker, Newbury Park, CA (US)

(21) Appl. No.: 15/915,548

(22) Filed: Mar. 8, 2018

Related U.S. Application Data
(60) Provisional application No. 62/479,906, filed on Mar. 31, 2017.

(51) Int. Cl. B60C 17/06; B60C 5/00

(52) U.S. Cl. CPC B60C 17/065; B60C 2200/12; B60C 2200/14; B60C 5/008

(57) ABSTRACT

A tubeless tire on a rim having a hollow core foam insert in the cavity of the tire and a loop of elastic material holding the foam insert in a relatively closed loop against the rim. The foam insert has a length that equals or almost equals the circumference of the rim. The loop of elastic material passes through the hollow core of the foam insert and also has a length that equals the circumference of the rim.

### RELATED APPLICATION

This application claims the benefit of U.S. Provisional Application No. 62/479,906, filed on Mar. 31, 2017.

### BACKGROUND OF THE INVENTION

The present invention is directed generally to the field of tubeless tires for vehicles, particularly cycles. More particularly, the present invention is directed to tubeless tires for cycles (e.g., bicycles, mountain bikes, motorcycles, dirt cycles, etc.) that are intended to operate with minimal or zero air pressure.

In such cycles, it is often desirable to operate without an inflatable tube so as to minimize the occurrence of a puncture of the tube and resultant need to replace the same before resuming use, sometimes on the road, trail, or track. However, even tubeless tires require the use of some minimal amount of air pressure.

The operation of tubeless tires often includes the use of liquid latex or similar rubberized liquid to seal the tire to the rim and elsewhere inside of the tire to aid in the retention of air pressure. The liquid latex inside the tire aids in sealing leaks that may occur in gaps between the tire and the rim. In addition, if a tire is punctured, residual liquid latex inside the tire can sometimes quickly seal the puncture if the hole is placed “downhill” so that the residual liquid latex flows to the hole and provides a temporary seal.

Particularly in downhill mountain biking, riders use minimal or zero air pressure in their tires so that if the tire is punctured or ripped, they can continue to ride without minimal change in performance. Because there is likely already very little air in the tires, the air lost to a puncture or tear will not make much difference in performance.

One major problem with riding on little to no tire pressure is the beating that rims (alloy, carbon fiber, or other material) take from bumps and rocks, particularly in mountain biking. A single rim running on no air pressure can usually only survive a few of runs before failing or otherwise needing to be replaced. To solve this problem, certain systems have been designed that fill all or part of the space between the tire and the rim with a foam material. The foam provides a structure to the tire similar to air, but without the need for providing an air tight seal. In addition, the foam provides a measure of protection to the rim against bumps and rocks encountered on the road.

Such foam systems typically seek to fill most of the interior of the tire with a solid volume of foam. Others include a denser core to provide more rigidity to the foam filler. Drawbacks of such systems include increased expense, added weight, difficulty in assembly and disassembly, to name a few.

Accordingly, there is a need for an airless tire system that has a reduced cost, reduced weight, and is easy to assemble and disassemble. The present invention fulfills these needs and provides other related advantages.

### SUMMARY OF THE INVENTION

The present invention is directed to a tubeless tire assembly having a tire mounted on a rim without an inflatable air tube between the tire and the rim. The inventive assembly has a foam insert disposed around a circumference of the rim and in a cavity on an interior of the tire. The foam insert has a hollow-core. An elasticized material is disposed in the hollow-core of the foam insert around the circumference of the rim. The elasticized material forms a closed loop.

Preferably, the foam insert has a length that approximately matches the circumference of the rim. If the length of the foam insert is shorter than the circumference of the rim, it is preferably by no more than half of a distance between two adjacent spokes on the rim. The closed loop of elasticized material also preferably has a length that approximately matches the circumference of the rim. The closed loop of elasticized material is configured to hold the foam insert to closely encircle the rim.

A tire sealant may be disposed between sidewall edges of the tire and sidewall edges of the rim. With the tire sealant, excess fluid tire sealant may be disposed in the cavity of the tire. Rim tape may also be disposed in a bottom channel of the rim. A valve stem may also pass through a bottom channel of the rim, and the rim tape if necessary.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1A is a cross-sectional, cut-away of a prior art tubeless tire and rim;

FIG. 1B is a cross-sectional, cut-away of a prior art tubeless tire and rim impacting on a deforming structure;

FIG. 2 is a partial cut-away, perspective view of a tubeless tire and rim of the present invention;

FIG. 3 is a close-up cut-away view of a tubeless tire and rim of the present invention;

FIG. 4 is a cross-sectional, cut-away of a tubeless tire and rim of the present invention;

FIG. 4A is a closeup view of the portion of FIG. 4 designated by circular arrow 4A; and

FIG. 5 is a cross-sectional, cut-away of a tubeless tire and rim of the present invention impacting on a deforming structure.

### DETAILED DESCRIPTION OF THE PREFERRED EMBODIMENTS

The present invention is directed to a tubeless, low-no pressure tire. The inventive tire was particularly designed and invented for use on downhill mountain bikes, may find application for bicycles, motorcycles, cars, or any other vehicle that needs to run on tires. While the following specification generally illustrates and describes the components and structural relationships of those components of the inventive tire in the context of a bicycle tire, the same components have advantageous use for tires for other types of vehicles.

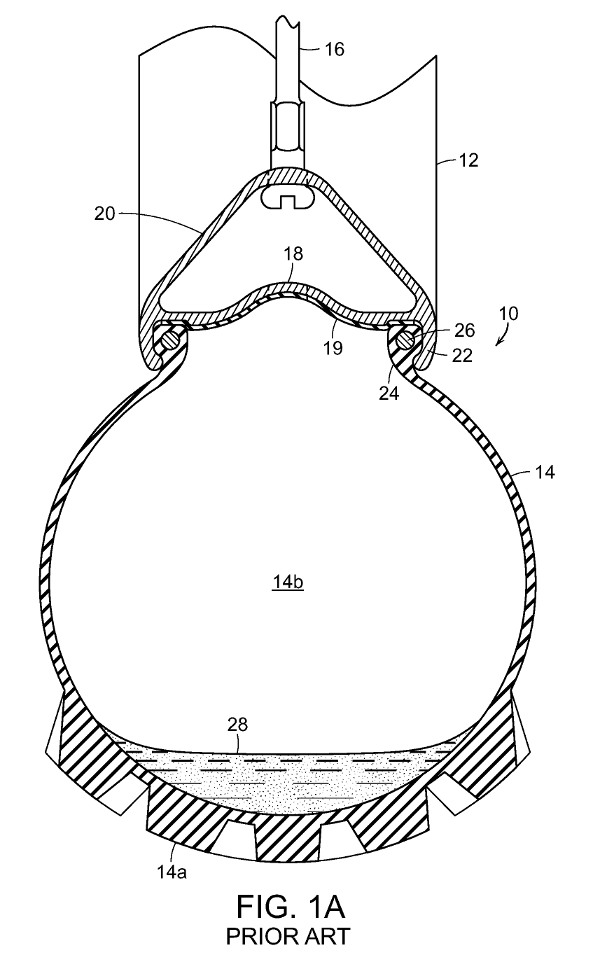

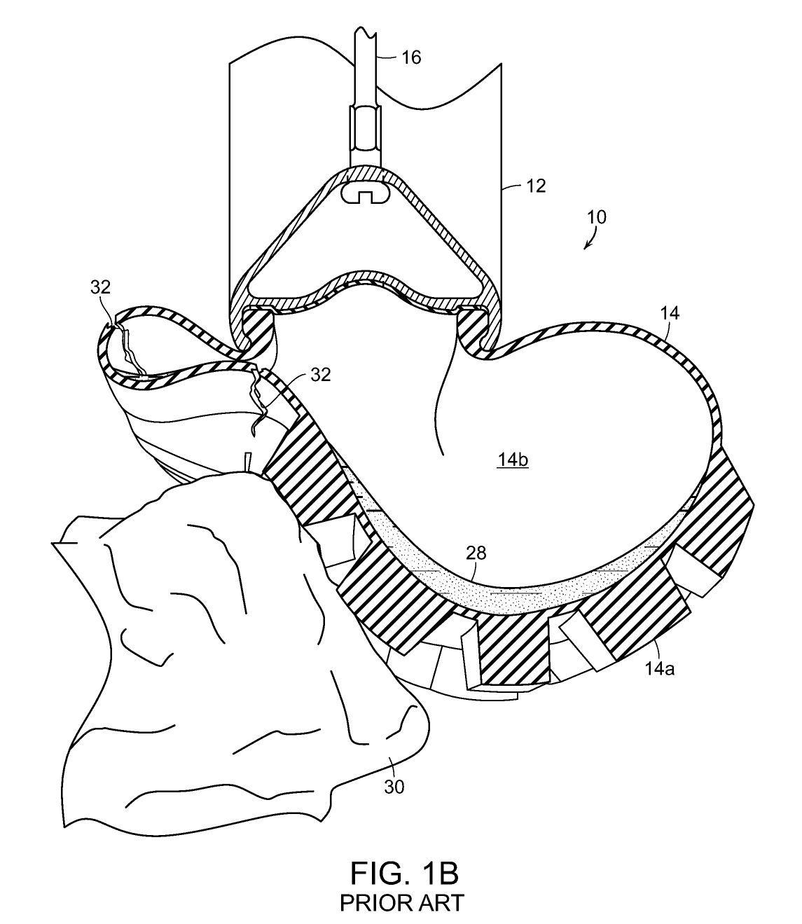

FIGS. 1A and 1B generally illustrate prior art tubeless tires, generally referred to by reference numeral 10. Depending upon the specific construction as described below, such tubeless tires 10 may be operable with standard air pressure, no air pressure, or any air pressure in between.

In these figures, the prior art tubeless tires 10 includes a rim 12 and a tire 14. The tire 14 preferably includes treads 14a as is commonly found on such tires. The rim 12 includes one or more spokes 16, along with a bottom channel 18. While illustrated with a gap between the bottom channel 18 and an annular surface 20 where the spokes 16 attach, a rim may combine the bottom channel 18 and the annular surface 20 into a single layer. The bottom channel 18 may include a layer of rim tape 19 designed to help seal the bottom channel 18 against air leaks, particularly when the spokes 16 connect through the bottom channel 18.

The bottom channel 18 is bounded on either side by rim sidewalls 22, which are configured to receive and retain tire sidewalls 24 as shown. The tire sidewalls 24 may include reinforcing cords 26 as shown in FIG. 1A. Such reinforcing cords 26 may also be omitted as shown in FIG. 1B. A tire adhesive (not shown) may be included between the rim sidewalls 22 and tire sidewalls 24. The tire adhesive, along with the rim tape 19 helps the tubeless tire 10 to maintain at least a minimal amount of air pressure, if not a standard amount, even without a tube. Additional fluid tire adhesive 28 may remain in the tire 14 in the bottom of the cavity 14b following the force of gravity.

In a typical tubeless tire 10, when the tire 14 impacts a rock or other obstacle 30, the tire 14 is compressed and folded to an extreme degree. As shown in FIG. 1B, the tread portion 14a may be pushed completely against the rim sidewall 22 and the material of the tire 14 may form breaks, cracks, or tears 32. Such action can damage the rim sidewall 22 and/or cause the tire 14 to lose integrity. During a ride, as down a mountain or on other surface, a tubeless tire 10 that loses integrity may become inoperable such that the ride must end until the tubeless tire 10 can be repaired.

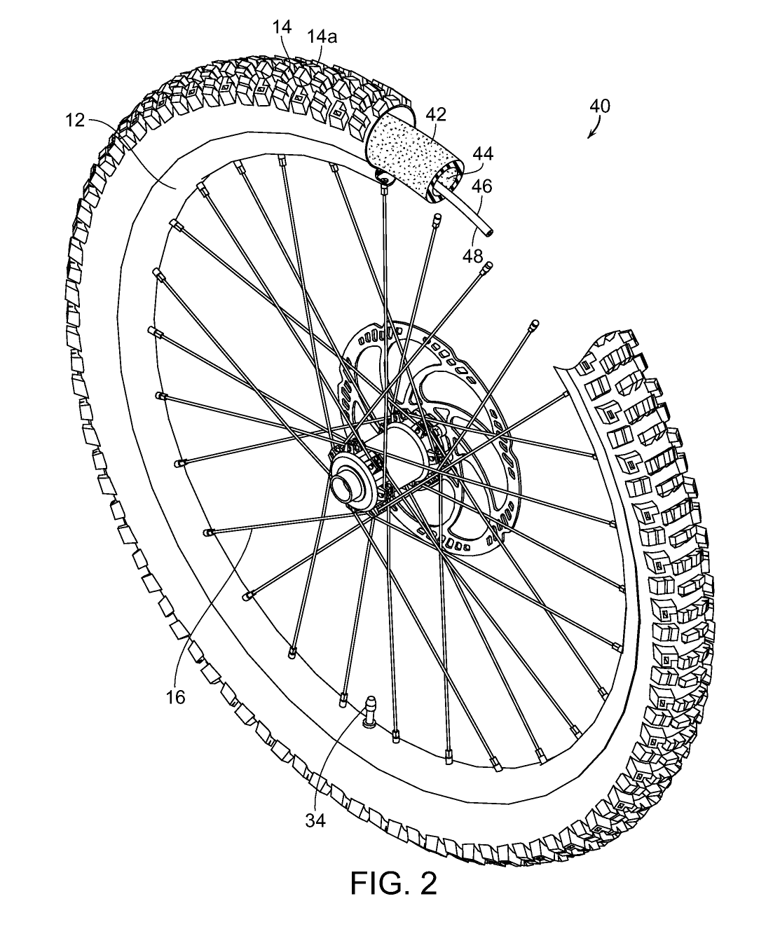

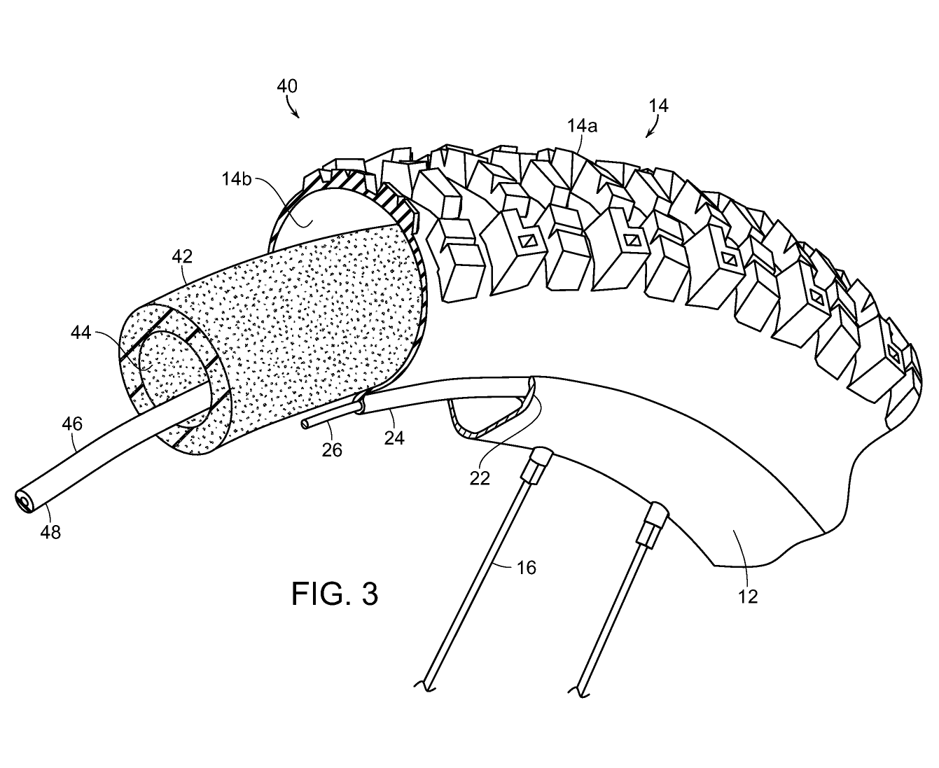

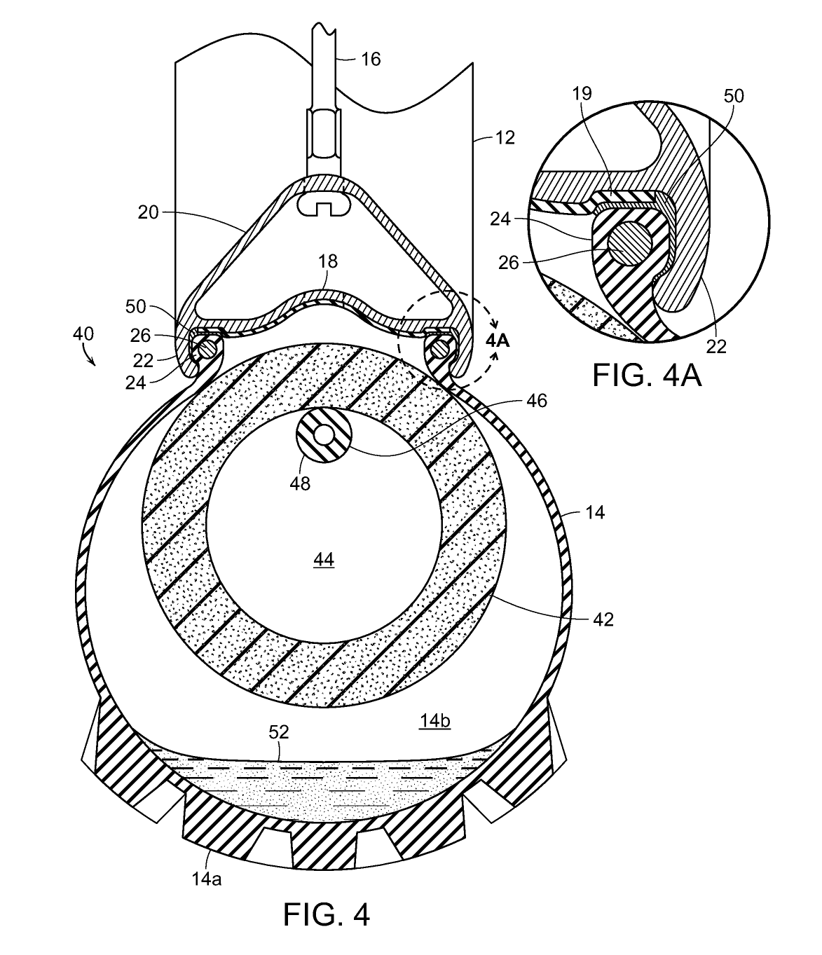

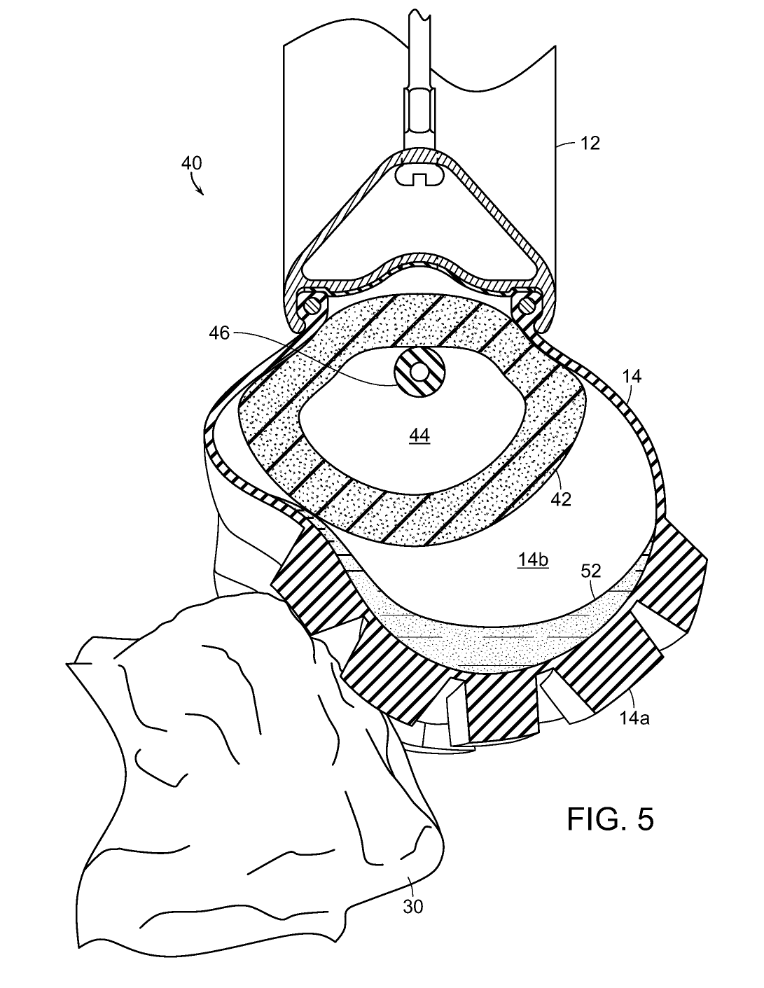

As shown in FIGS. 2-5, the inventive tubeless tire 40, is similarly constructed with the rim 12 and tire 14, having similar components and construction. The difference from the prior art lies in the inclusion of a foam insert 42 having a hollow-core 44 that fits within the cavity 14b of the tire 14. The foam insert 42 is selected with sufficient length to match the circumference of the rim 12. Preferably the foam insert 42 completely encircles the rim 12, but the objects of the invention are still achieved if the length of the foam insert 42 is slightly shorter than the circumference of the rim 12. Ideally, any shortage in the length of the foam insert 42 relative to the circumference of the rim 12 is less than half the distance between two spokes 16 on the rim 12.

The tubeless tire 40 also includes an elasticized material 46 disposed in the hollow-core 44 of the foam insert 42. The elasticized material 46 is formed into an elasticized loop 48. The length of the elasticized material 46 is again of a sufficient length so that the elasticized loop 48 matches the circumference of the rim 12. The elasticized material 46 preferably passes through the hollow core 44 of the foam insert 42 so that the elasticized loop 48 is disposed entirely within the hollow-core 44 of the foam insert 18. When the elasticized material 46 is closed into the elasticized loop 48, it is configured to hold the foam insert 42 to closely encircle the rim 12.

The elasticized material 46 may be any type of rubber or similar material that provides sufficient tension to retain the foam insert 42 in contact with rim 12. Such rubberized material can include a simple rubber band, rubberized surgical tubing, or similar materials with sufficient durability to remain intact during typical use in downhill mountain biking runs. The elasticized material 46 is preferably formed in the loop 48 as by being molded, but it may also be tied or secured by other mechanisms such as clips to attach the two ends of the length of elasticized material 46 together into the loop 48.

As in the prior art version, a tire sealant 50 is disposed between the edges of the tire sidewalls 24 and the edges of the rim sidewalls 22. Fluid tire sealant 52 may also be disposed in the cavity 14b of the tire 14. The fluid tire sealant 52 is simply excess material that is permitted to remain in the tire 14. When the tire experiences a puncture, hole, tear, or similar failure 32, the fluid tire sealant 52 is designed to flow into the failure 32 and provide a temporary seal. Even with a minimal amount of air pressure in the tire 14, the outflow of air through the failure 32 will draw some of the fluid tire sealant 52 into the failure 32.

As with the prior art version, the inventive tubeless tire assembly 40 may also include rim tape 19 disposed in a bottom channel 18 of the rim 12. The tubeless tire assembly 40 may also include a valve stem 34 passing through a bottom channel 18 of the rim 12 and, if necessary, the rim tape 19.

The inventive tubeless tire 40 is assembled using similar steps as a prior art tube-less tire. First, the tire 14 is placed partly on the rim 12 so that one tire sidewall 24a is inside the bottom channel 18 of the rim 12 and the other tire sidewall 24b is outside the rim 12. A length of foam insert 42 is selected to match the circumference of and preferably completely encircle the rim 12. However, the objects of the invention can still be achieved if the foam insert 42 is slightly shorter than the circumference of the rim 12.

Next, the length of elasticized material 46 of a sufficient length to match the circumference of the rim 12 threaded through the hollow core 44 of the foam insert 42 so that when the elasticized material is formed into a closed loop 48 it closely holds the foam insert 42 in a loop about the rim.

The combined hollow foam insert 18 and concentric elasticized loop 20 are then inserted into the cavity 14b of the tire 14 and the other tire sidewall 24b is positions inside of the rim 12. The tire sidewalls 24 may be secured to the rim sidewalls 22 by latex sealant or other commonly used tire sealant 50.

Once fully assembled, the inventive tubeless tire 40 may be inflated with air to any desired or normal tire pressure. The tubeless tire 40 would operate as intended when fully pressurized. In the event that the tubeless tire 40 loses air pressure as by a puncture or tear 32, the foam insert 42 and elastic loop 48 come into effect.

In a prior art tubeless tire 10 lacking air pressure, the rubber tire 14 would flatten against the rim 12 when any weight was applied to the tubeless tire 10. With the inventive tubeless tire 40, when the rubber tire 14 flattens, the foam insert 42 also flattens. The foam insert 42 provides protection for the rim 12 against damaging impacts from rocks and other hard obstacles 30 that the tubeless tire 40 may impact. In addition, because the foam insert 42 has a hollow core 44, it can more closely match the flattening of the rubber tire 14, which is also hollow. A solid core foam insert would not be capable of the same lateral expansion through flattening as the hollow core 44 foam insert 42. Because of this, the solid core foam inserts do not provide the protection against creasing or excessive folding that the hollow core foam insert 42 provides.

By more closely matching the flattening of the rubber tire 14, the foam insert 42 provides protection not only to the rim 12 but the material of the rubber tire 14, as well, to prevent creasing or similar excessive folding, which can result in splitting or cracking 32. The elastic loop 48 helps to hold the foam insert 42 in place and against the rim 12 both during installation and use. Without the elastic loop 48, the foam insert 42 may float away from the rim 12 or become off-center in the tubeless tire 40 and not provide complete protection to the rim sidewalls 22 and tire 14. The elastic loop 48 also ensures that the foam insert 42 remains generally in a snug loop about the rim 12 rather than two ends of the foam insert 42 spreading apart and exposing a larger portion of the rim 12 and/or rubber tire 14 to potential damage.

Although several embodiments have been described in detail for purposes of illustration, various modifications may be made without departing from the scope and spirit of the invention. Accordingly, the invention is not to be limited, except as by the appended claims.

What is claimed is:

1. A tubeless tire assembly having a tire mounted on a rim without an inflatable air tube between the tire and the rim, comprising:
a foam insert disposed around a circumference of the rim and in a cavity on an interior of the tire, wherein the foam insert has a hollow-core; and
an elasticized material disposed in the hollow-core of the foam insert around the circumference of the rim, wherein the elasticized material forms a closed loop.

2. The tubeless tire assembly of claim 1, wherein the foam insert has a length that approximately matches the circumference of the rim.

3. The tubeless tire assembly of claim 2, wherein the length of the foam insert is shorter than the circumference of the rim by no more than half of a distance between two adjacent spokes on the rim.

4. The tubeless tire assembly of claim 1, wherein the closed loop of elasticized material has a length that approximately matches the circumference of the rim.

5. The tubeless tire assembly of claim 1, wherein the closed loop of elasticized material is configured to hold the foam insert to closely encircle the rim.

6. The tubeless tire assembly of claim 1, further comprising a tire sealant disposed between sidewall edges of the tire and sidewall edges of the rim.

7. The tubeless tire assembly of claim 6, further comprising fluid tire sealant disposed in the cavity of the tire.

8. The tubeless tire assembly of claim 6, further comprising rim tape disposed in a bottom channel of the rim.

9. The tubeless tire assembly of claim 6, further comprising a valve stem passing through a bottom channel of the rim.

10. A tubeless tire assembly having a tire mounted on a rim without an inflatable air tube between the tire and the rim, comprising:
a foam insert having a length that approximately matches a circumference of the rim, the foam insert disposed around the circumference of the rim and in a cavity on an interior of the tire, wherein the foam insert has a hollow-core; and
an elasticized material disposed in the hollow-core of the foam insert around the circumference of the rim, wherein the elasticized material forms a closed loop having a length that approximately matches the circumference of the rim.

11. The tubeless tire assembly of claim 10, wherein the length of the foam insert is shorter than the circumference of the rim by no more than half of a distance between two adjacent spokes on the rim.

12. The tubeless tire assembly of claim 10, wherein the closed loop of elasticized material is configured to hold the foam insert to closely encircle the rim.

13. The tubeless tire assembly of claim 10, further comprising a tire sealant disposed between sidewall edges of the tire and sidewall edges of the rim.

14. The tubeless tire assembly of claim 13, further comprising fluid tire sealant disposed in the cavity of the tire.

15. The tubeless tire assembly of claim 13, further comprising rim tape disposed in a bottom channel of the rim.

16. The tubeless tire assembly of claim 13, further comprising a valve stem passing through a bottom channel of the rim.

17. A tubeless tire assembly having a tire mounted on a rim without an inflatable air tube between the tire and the rim, comprising:
a foam insert having a length that approximately matches a circumference of the rim, the foam insert disposed around the circumference of the rim and in a cavity on an interior of the tire, wherein the foam insert has a hollow-core;
an elasticized material disposed in the hollow-core of the foam insert around the circumference of the rim, wherein the elasticized material forms a closed loop having a length that approximately matches the circumference of the rim and is configured to hold the foam insert to closely encircle the rim;
rim tape disposed in a bottom channel of the rim, said rim tap having a length generally matching the circumference of the rim; and
a tire sealant disposed between sidewall edges of the tire and sidewall edges of the rim.

18. The tubeless tire assembly of claim 17, wherein the length of the foam insert is shorter than the circumference of the rim by no more than half of a distance between two adjacent spokes on the rim.

19. The tubeless tire assembly of claim 17, further comprising fluid tire sealant disposed in the cavity of the tire.

20. The tubeless tire assembly of claim 17, further comprising a valve stem passing through a bottom channel of the rim and the rim tape.
